(19) United States
(12) Patent Application Publication
(10) Pub. No.: US 2025/0378244 A1
(43) Pub. Date: Dec. 11, 2025

(54) DISCRETIZING AN AIRCRAFT SURFACE INTO P-STATIC ZONES

(71) Applicant: The Boeing Company, Arlington, VA (US)

(72) Inventors: Derek R. Tuck, Ladson, SC (US); Joe Heeter, Sammamish, WA (US); Brendan S. Finn, Lake Stevens, WA (US); Anthony R. Hangartner, Redondo Beach, CA (US)

(21) Appl. No.: 18/735,957

(22) Filed: Jun. 6, 2024

(51) Int. Cl. G06F 30/28; G06F 113/08; G06F 113/28

(52) U.S. Cl. CPC G06F 30/28; G06F 2113/08; G06F 2113/28

(57) ABSTRACT

A method is presented for discretizing an aircraft surface into p-static zones. The method comprises generating a particle impingement model for an aircraft surface using computational fluid dynamics. The particle impingement model is discretized to generate two or more p-static zones. P-static design guidelines are established on a per p-static zone basis. Unbonded conductive material and/or dielectric material is then applied to the aircraft surface based on the p-static design guidelines.

### FIELD

The present disclosure relates generally to triboelectric charging of aircraft surfaces, and in particular, to modeling zones of the aircraft surface based on particle impingement and precipitation charging profiles.

### BACKGROUND

Precipitation static (p-static) refers to electrostatic charging of aircraft surfaces due to collision with particles during flight. Impingement of particles transfers charge at the point of impact on the aircraft exterior, resulting in electrostatic charge accumulation. This can cause interference with aircraft navigation and communication systems by broadband discharges. Since aircraft cannot realistically avoid operating in situations where p-static charging occurs, manufacturers design and certify aircraft in terms of p-static performance by envisioning “worst case scenario” situations, despite the fact p-static charging can be non-uniform. This leads to excessive expense and overly conservative designs.

### SUMMARY

A method is presented for discretizing an aircraft surface into p-static zones. The method comprises generating a particle impingement model for an aircraft surface using computational fluid dynamics. The particle impingement model is discretized to generate two or more p-static zones. P-static design guidelines are established on a per p-static zone basis. Unbonded conductive materials and/or dielectric materials are then applied to the aircraft surface based on the p-static design guidelines.

This Summary is provided in order to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any disadvantages noted in any part of this disclosure.

### BRIEF DESCRIPTION OF THE DRAWINGS

FIG. 1 shows an example aircraft flying through suspended atmospheric particles.

FIG. 2 shows a flow diagram for an example method for discretizing an aircraft surface into p-static zones.

FIGS. 3A-3B show particle impingement on an aircraft surface for 50 μm particles.

FIGS. 3C-3D show particle impingement on an aircraft surface for 200 μm particles.

FIGS. 3E-3F show particle impingement on an aircraft surface for 1000 μm particles.

FIG. 4 shows example positioning of charging Patches and instrumented static dischargers on an aircraft surface.

FIG. 5 shows an example plot of total accumulated charge density for charging patches as compared vs. β from a 1000 μm particle impingement model.

FIG. 6A schematically shows p-static zones for an aircraft fin.

FIG. 6B schematically shows p-static zones for an aircraft airfoil.

FIG. 7 illustrates unbonded conductive material and dielectric material applied to an aircraft fin on a per p-static zone basis.

FIG. 8 schematically shows aspects of an example computing system.

### DETAILED DESCRIPTION

Aircraft flying through suspended atmospheric particles, including dust, ice crystals, and precipitation, are subject to accumulating electric charge through the triboelectric effect and charged particle exchange. Surface charge accumulates on the aircraft surface and dissipates into structure. Additional charging of aircraft can be observed when flying through strong electric fields. If not properly dissipated, this charge can accumulate on different locations and create localized arcing, resulting in high localized currents and electromagnetic fields. These fields can couple to aircraft communication and navigation systems. This aircraft charging and antenna coupling phenomena is commonly referred to as p-static interference. Federal Aviation Administration (FAA) regulations govern normal aircraft operation in severe p-static environments when designing aircraft.

General guidance for p-static design includes electrical bonding of all exterior conductive surfaces to structure and applying anti-static coatings to nonconductive surfaces and bonding these to structure. P-static design currently treats the entire aircraft as worst-case charging areas or relies on qualitative arguments to relieve requirements in low threat areas. For example, qualitative arguments may be based on how a particular aircraft design fared in practice, then assuming that the design guidelines transfer to other aircraft types. These qualitative arguments generate conservative assessments. However, public domain sources indicate that p-static aircraft charging is not uniform, as it depends on the number of particles impacting the aircraft. Treating the entire aircraft as worst case leads to overly conservative guidelines and increased cost.

The p-static guidelines extend to the e use of unbonded conductive materials (i.e., isolated electrical conductors) and dielectric materials on aircraft surfaces. Such materials include speed tape and decals commonly used in-service. In general, external surfaces of the aircraft are to be bonded to each other and then connected to the structure of the aircraft so that any accumulated charge dissipates. As such, speed tape and decal placement are limited, even if the placement of the unbonded conductor is in a low charging part of the aircraft surface.

“Speed tape,” a common name used in the aviation industry, is a dead soft aluminum foil tape with a polymer-based pressure sensitive adhesive that is used to cover damaged surface finishes to prevent ultraviolet (UV) degradation of the exposed unpainted surface. Examples include speed tape with 4.3 mil thick aluminum foil with 1.3 mil adhesive (3M425) or 3 mil thick aluminum foil with 2 mil of acrylic adhesive (Permacel P11). Installation includes applying the tape to a damaged surface.

Speed tape thus comprises an electrically isolated conductor due to dielectric properties of the pressure sensitive adhesive. Adhesives used on speed tape are generally polymer acrylic based which have a bulk resistivity much greater than the resistivity that is considered static dissipative. When exposed to triboelectric (e.g., frictional) charging, such as ice particles impinging on airplane surfaces, electrical charge accumulates on the exposed foil until the voltage between the aluminum foil and structure and/or at foil/foil interfaces exceeds the standoff capability of the adhesive layer. This causes periodic uncontrolled discharge at the edges of the tape and through the adhesive. These periodic discharges are radio frequency (RF) sources that propagate RF energy. Such RF energy has the potential to interfere with communication and navigation systems. Interference is dependent on the magnitude and spectra of the RF source received by the system and sensitivity of the system.

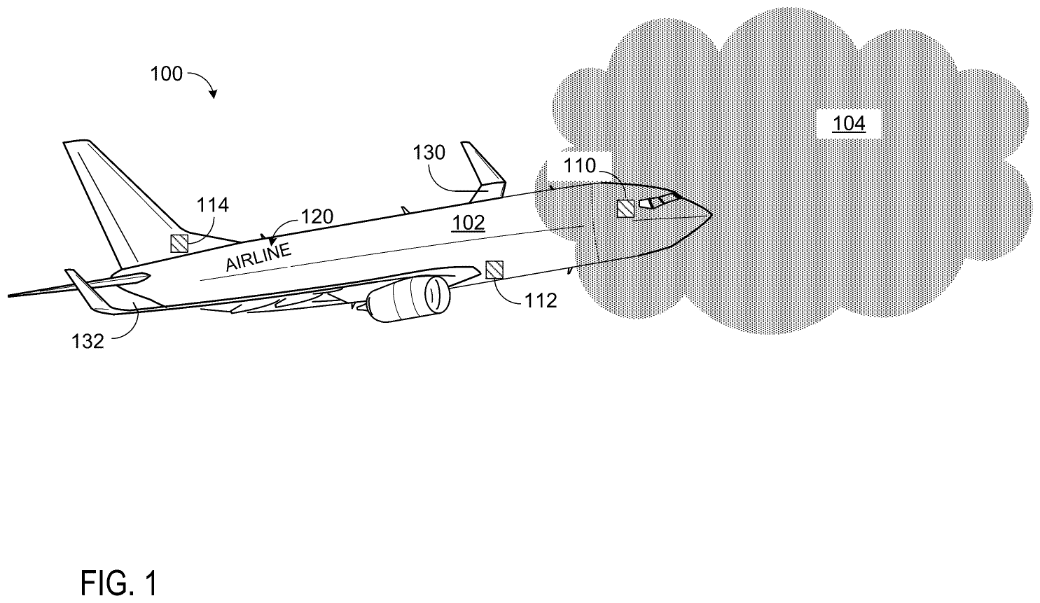

As an example, FIG. 1 depicts an aircraft 100 with an aircraft surface 102. Although primarily described with regards to commercial airliners, “aircraft” as used herein may describe airplanes, non-traditional aircraft, such as fixed wing aircraft and/or vertical take-off and landing aircraft, autonomous and semi-autonomous aircraft, as well as spacecraft, satellites, etc. Aircraft 100 is shown flying through suspended atmospheric particles 104. Speed tape patches are shown on aircraft surface 102 at 110, 112, and 114. A decal 120 is also positioned on aircraft surface 102. Static dischargers 130 and 132 are also positioned on aircraft surface 102. Typical speed tape repair application areas are on the nose aft of the landing gear and on the forward wing to body panels. Typical application areas rarely exceed 2 square feet. However, some aircraft are particularly prone to upper wing skin damage, resulting in, much more speed tape being used. Placement of speed tape repairs of total area in specific impingement regions of the nose, wing and empennage on the flight test airplane provides a basis for assessing impact on airplane communications.

The potential for p-static interference on communication and navigation systems is dependent on the charging environment and discharge location, magnitude, and frequency. Certain aircraft are prone to excessive in-service paint damage, and thus rely heavily on speed tape repairs to stay in commission until repainting can occur. Excessive speed tape in high charging areas thus has the potential of generating RF emissions that could affect communication and navigation performance within inclement weather.

The methodology disclosed herein provides aircraft design guidance based on p-static zoning, which takes into account that different areas of an aircraft have different p-static charging threat levels. These different zones are arrived upon via a process that comprises defining a particle impingement profile with a computational fluid dynamics (CFD) model. The CFD model may be validated with a charging profile in p-static flight testing. For example, charge sensors may be positioned on the aircraft surface to gauge charging rates at specific locations of the aircraft surface. The model is then discretized to create p-static zones, with zones having more severe charging profiles having more stringent design guidelines and zones with less severe charging profiles having less stringent design guidelines. This, in turn, reduces risk in p-static mitigation efforts and informs design guidelines for outer mold line materials such as coatings, tapes, and decals, leading to cost savings and cost avoidance in aircraft maintenance. Further, this may improve vendor satisfaction, as airline carriers can use larger decals in certain areas with more variety in materials.

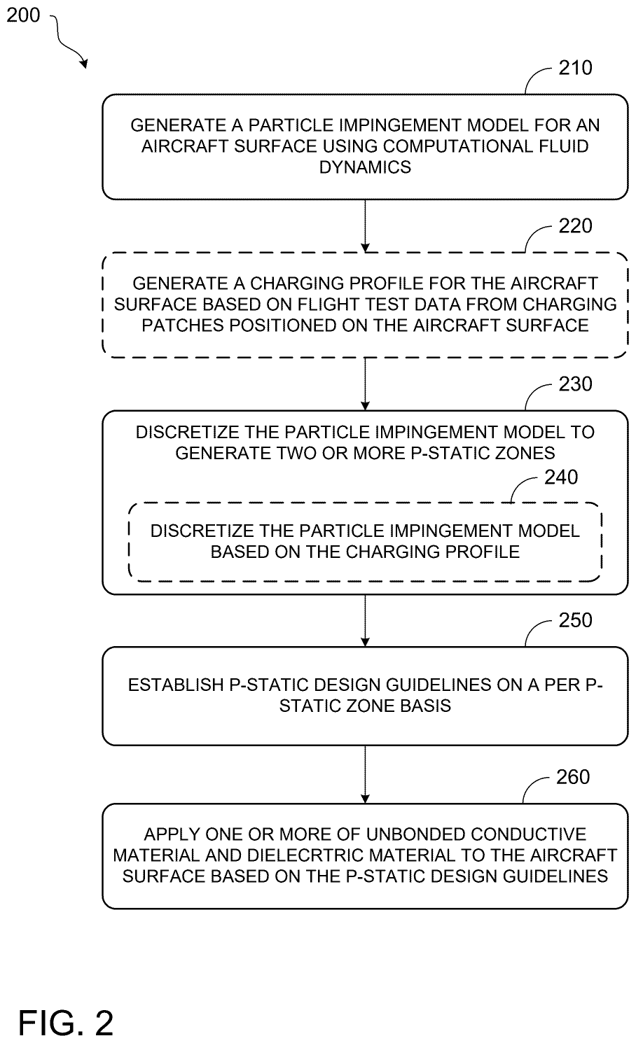

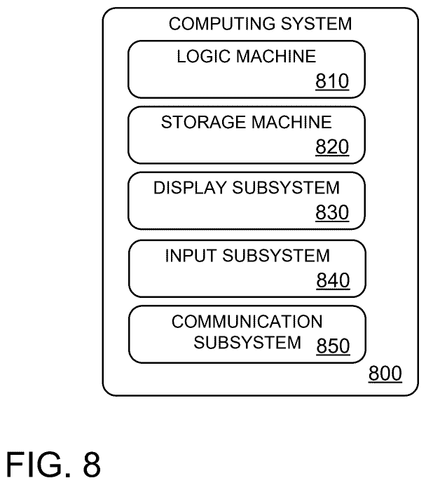

FIG. 2 shows a flow diagram for an example method 200 for discretizing an aircraft surface into p-static zones. Method 200 may be performed in conjunction with one or more computing devices. An example computing device is described herein and with regard to FIG. 8. Method 200 may be performed in conjunction with one or more aircraft.

At 210, method 200 comprises generating a particle impingement model for an aircraft surface using computational fluid dynamics (CFD) modelling. The CFD model is a calculation that can be performed with regard to icing impingement and buildup on the nacelle lips (e.g., part of the wing repair area with cumulative area applicable to both wing and nacelles.) or wings. The CFD model may be considered a ballistic model (e.g., Navier-Stokes based model derivation) where particles of differing sizes may be put into analysis to determine where the impingement locations are on the aircraft surface. The analysis may account for wind speed and other atmospheric conditions, but may be considered static e.g., does not consider motion. In some examples, other ballistic models may be employed. Computational fluid dynamic (CFD) analysis of particle impingement on the airplane may be used to determine placement of repair patches.

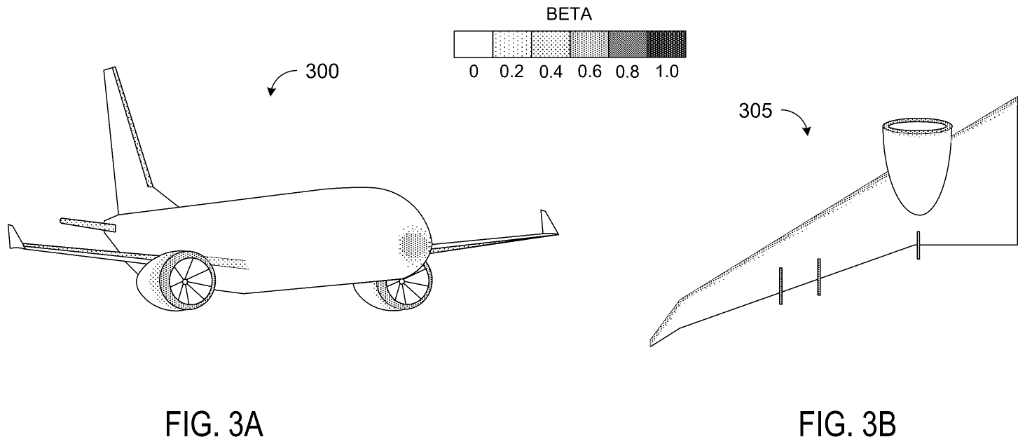

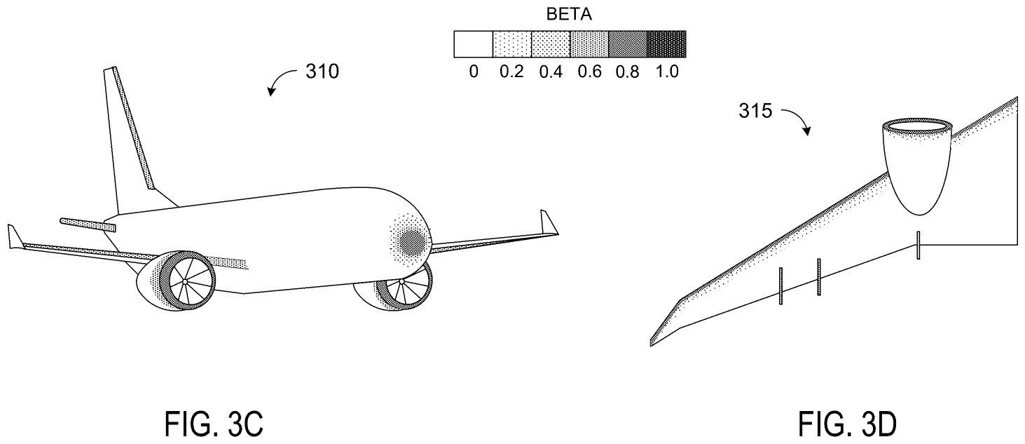

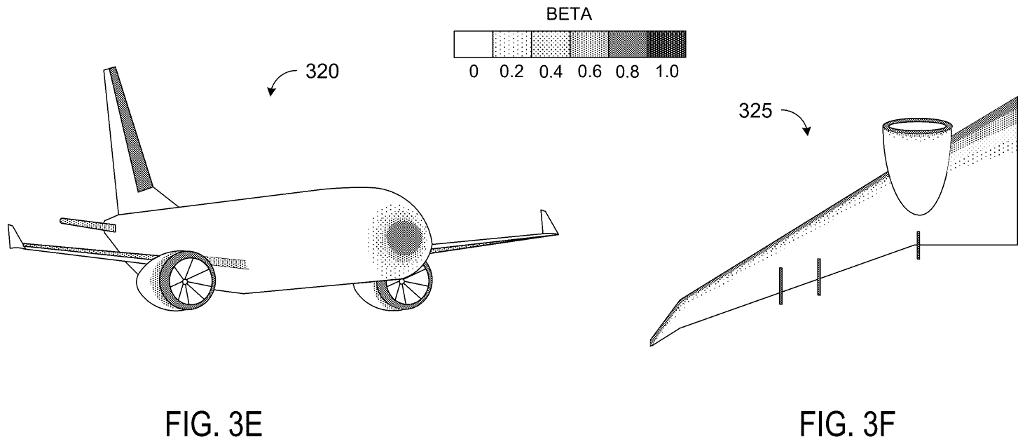

FIGS. 3A-3F show one example of CFD analysis according to the present disclosure. The analysis is an impingement static model with select particle sizes. The model used a “bouncing off” representation of particle impingement with the airplane at cruise altitude (39,000 ft), speed and cruise angle of attack (AOA). Three simulations were run, with particle sizes 50 μm (FIGS. 3A-3B), 200 μm (FIGS. 3C-3D) and 1000 μm (FIGS. 3E-3F). Unspeckled portions of the depicted aircraft have a negligible value for β, used as a measure of particle impingement. Heavier speckled portions of the depicted aircraft have progressively larger values for β.

The 50 μm (FIGS. 3A-3B) and 200 μm (FIGS. 3C-3D) models simulated min/max range of precipitation particles. The 1000 μm particle model (FIGS. 3E-3F) simulates an upper bound case. The output of this model is the value β that describes the particle impingement, where β=0 indicates no particle impingement and β is at its maximum where particle impingement is at a maximum. β is defined as the local droplet flux rate at the body surface normalized to the freestream flux rate. β is a function of droplet size and can be expressed as the local impingement efficiency for any point on the body surface.

FIG. 3A shows a head-on depiction 300 of an aircraft. FIG. 3B shows an underside 305 of an aircraft wing. Particle impingement (for particle sizes of 50 μm) is notable in aircraft surface regions including on the nose of the aircraft, on the leading edge of the wings, on the engine housings, on the leading edge of the stabilizers, and on the leading edge of the fin.

FIG. 3C shows a head-on depiction 310 of an aircraft. FIG. 3D shows an underside 315 of an aircraft wing. Particle impingement regions (for particle sizes of 200 μm) with a positive value for β are similar to those particle impingement regions shown for FIGS. 3A and 3B. However, values for β in those regions are increased over those for 50 μm particles, and the regions have larger surface area as compared to those for 50 μm particles.

FIG. 3E shows a head-on depiction 320 of an aircraft. FIG. 3F shows an underside 325 of an aircraft wing. Particle impingement regions (for particle sizes of 1000 μm) with a positive value for β, are similar to those particle impingement regions shown for FIGS. 3C and 3D. However, values for β in those regions are increased over those for either 50 or 200 μm particles, and the regions have larger surface area as compared to those for either 50 or 200 μm particles.

One characteristic that the particle impingement simulation results indicate is that β regions from the 1000 μm particle have the largest impingement area as compared to smaller sized particles, where the impingement area is relatively smaller due to the aerodynamic interaction with the particles. Larger, heavier particles (e.g., 1000 μm) are less affected by the airstream and therefore impinge farther aft than smaller particles and over a larger portion of the aircraft surface as compared to smaller particles. Notably, the higher β regions do not shift aft as much compared to the lower β regions for larger particles.

Returning to FIG. 2, optionally, at 220, method 200 comprises generating a charging profile for the aircraft surface based on flight test data from charging patches positioned on the aircraft surface. Charging patches can be positioned on the aircraft surface based on the particle impingement model. The charging profile for the aircraft surface can be further based on flight test data from instrumented static dischargers positioned on the aircraft surface.

The charging patches provide a charging profile of the airplane in flight. Charging patches may be placed strategically at different angle of attack regions around different parts of the aircraft surface to inform the charging rate for an aspect angle of the exposed aircraft surface. A charging profile may be generated including a charging current density at a diverse set of points around the aircraft surface.

A charging patch at the most forward part of the wing may correlate to the highest charging area of the aircraft surface, while a charging patch on the fuselage might not experience as much charging. Data can be collected from regions of the aircraft surface that span the range from lowest particle impingement to most particle impingement. Overall, the charging patches may span a large range of different particle impingement βvalues (e.g., 0.01 to 1) and different charging profiles across the aircraft, allowing for validation of the entire CFD model.

The function of each charging patch is to provide particle impingement charging rate data with respect to airplane speed and effective charging area with respect to the angle of attack (AOA) of the impinging particles. The charging patch simply measures current from triboelectric charge separation from impinging suspended precipitation particles. Current magnitude is a function of particle type and size, particle charge, particle density, area of charging patch, patch AOA, patch material, the aero-boundary layer, and aircraft speed. The effective area of the charging patch correlates with the interaction of particles based on the projected frontal area of the patch. Essentially, the higher the AOA, with respect to the AOA of the airplane, the lower the effective charging area.

Impinging particles generate relatively small charge exchanges so measurements are generally amplified. Such patches themselves may be-by way of non-limiting example-an electrically isolated strip of 3M425 speed tape (e.g., measuring 1″ wide by 4″) spanwise, positioned on top of a layer of urethane tape. A corona guard ring may be positioned around the patch which helps reduce brush discharges from the urethane tape and from surrounding composite surfaces. The patch may be attached to a resistor in parallel with an amplifier module. The wiring may include an RF shield attached to the corona guard ring and at the pressure vessel penetration. Such a shield reduces electromagnetic interference (EMI) and provides a ground for the corona guard. The transient suppression device clamps conducted and induced voltages into the pressure vessel in the event of a lightning attachment to or near the patch. The transient suppression device also clamps conducted and induced voltages at the pressure vessel in the event of a lightning attachment to or near the Instrumented Static Dischargers (ISDs).

Patch placement may be determined at least in part based on the β values for the aircraft surface generated via CFD analysis. In one example, individual charging patches were applied to a fixed leading-edge surface with patches positioned at 0°-10°, 20°-30°, 45°-50°, 65°-70° and 85° with respect to the forward apex of the leading-edge surface. It has been shown that ice crystals to snow particles have an impingement area between 10° to 30° with larger particles such as water droplets including an impingement angle up to 40°.

The ISDs are trailing type static dischargers that have been modified to electrically isolate the static wick (resistive rod) from the discharger base (housing) and attach a wire to the isolated static wick. This allows the wiring to be attached to instrumentation, allowing measurement of discharge current at the mounted location of each ISD. Similar to the charging patches, the transient suppression device clamps conducted and induced voltages at the pressure vessel in the event of a lightning attachment to or near the ISDs and do not affect the measured discharge current. ISDs measure the discharge rate of the airplane. ISDs are more susceptible to exogenous charging, whereas the charging patches respond more to frictional charging. This combination of charge patches and ISDs helps to separate exogenous charging from triboelectric charging. The measurements from the most outboard ISDs are used to establish the most severe airplane charging environment during operation of communication and navigation systems. They also help delineate triboelectric charging conditions from exogenous electrification of the airplane. The outputs of the other ISDs aid in understanding the airplane charging environment and verification of triboelectric charging of the airplane. They also provide insight into charge redistribution on the airplane for analysis.

Charging patches may be positioned at specific angles with respect to 0° pitch (e.g., parallel to horizon not including the angle of attack of the airplane) on the leading edge of the left wing and vertical stabilizer. These patches establish the triboelectric charging environment with respect to angle of attack (AOA).

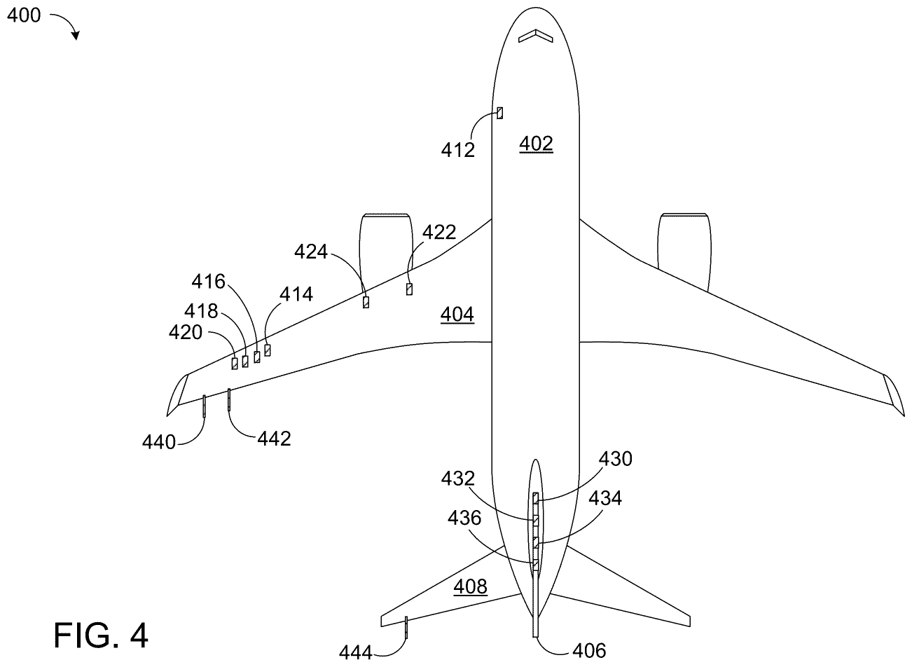

FIG. 4 shows an example aircraft 400 with charging patches and ISDs mounted on the aircraft surface. Four regions of the airplane were selected for patch placement including the fuselage 402, two regions of left wing 404, and fin 406. The wing tip charging patches were installed on left leading edge of the wing. Instrumentation also includes instrumented static dischargers (ISDs) mounted on left wing 404 and left horizontal tip 408. The AOA for the patches were selected from past data and particle impingement regions of various particle sizes. A single patch 412 (fuselage 1) was placed on fuselage 402, with an approximate AOA of 90°. A four-patch cluster (left wing patch 1 414, left wing patch 2 416, left wing patch 3 418, left wing patch 4 420) was placed on the leading edge of the wing tip of left wing 404. Two patches (left wing patch 5 422 and left-wing patch 6 424) were placed midspan of left wing 404 at 85° AOA. A four-patch cluster (vertical fin patch 1 430, vertical fin patch 2 432, vertical fin patch 3 434, vertical fin patch 4 436) was placed on the leading edge of fin 406. ISDs were mounted on left wing 404 (ISDs 440 and 442) and the left horizontal tip 408 (ISD 444). The configuration shown in FIG. 4 is merely exemplary, and more or fewer charging patches and ISDs may be mounted on the aircraft surface in other examples. Locations for charging patches and ISDs may also vary.

Based on past data, the most forward two patches (left wing patch 1 414 and left-wing patch 2 416) would capture the highest amount of charge from a range of precipitation particle sizes, with left wing patch 3 318 and left-wing patch 4 420 being much lower. The midspan wing (422 and 424) and fuselage (412) patches, located in a β region less than 0.1, are intended to capture charging during severe charging conditions where the effective charging area is essentially zero.

Table 1 shows the location for each charging patch and its associated B value.

TABLE 1

| Patch Location | x (inch) | y (inch) | z (inch) | β |
|---|---|---|---|---|
| Left Wing Patch 1 | 1460 | 1065 | 292 | 0.75 |
| Left Wing Patch 2 | 1468 | 1073 | 294 | 0.53 |
| Left Wing Patch 3 | 1468 | 1074 | 293 | 0.26 |
| Left Wing Patch 4 | 1462 | 1065 | 290 | 0.17 |
| Left Wing Patch 5 | 1028 | 404 | 218 | 0.04 |
| Left Wing Patch 6 | 1107 | 522 | 229 | 0.08 |
| Fuselage 1 | 382 | 102 | 262 | 0.03 |
| Vertical Fin Patch 1 | 1917 | 0 | 420 | 0.88 |
| Vertical Fin Patch 2 | 1924 | 3 | 429 | 0.56 |
| Vertical Fin Patch 3 | 1919 | 4 | 418 | 0.38 |
| Vertical Fin Patch 4 | 1928 | 5 | 422 | 0.25 |

Table 2 shows total charge accumulated on charging patches for the duration of the flight test.

TABLE 2

| | Total Charge Accumulation |
|---|---|
| Patch | During Flight (C/m²) |
| Left Wing Patch 1 | 2.43 |
| Left Wing Patch 2 | 1.51 |
| Left Wing Patch 3 | 0.71 |
| Left Wing Patch 4 | 0.53 |
| Left Wing Patch 5 | 0.16 |
| Left Wing Patch 6 | 0.19 |
| Vertical Fin Patch 1 | 2.86 |
| Vertical Fin Patch 2 | 2.30 |
| Vertical Fin Patch 3 | 1.39 |
| Vertical Fin Patch 4 | 1.13 |
| Fuselage Patch 1 | 0.19 |

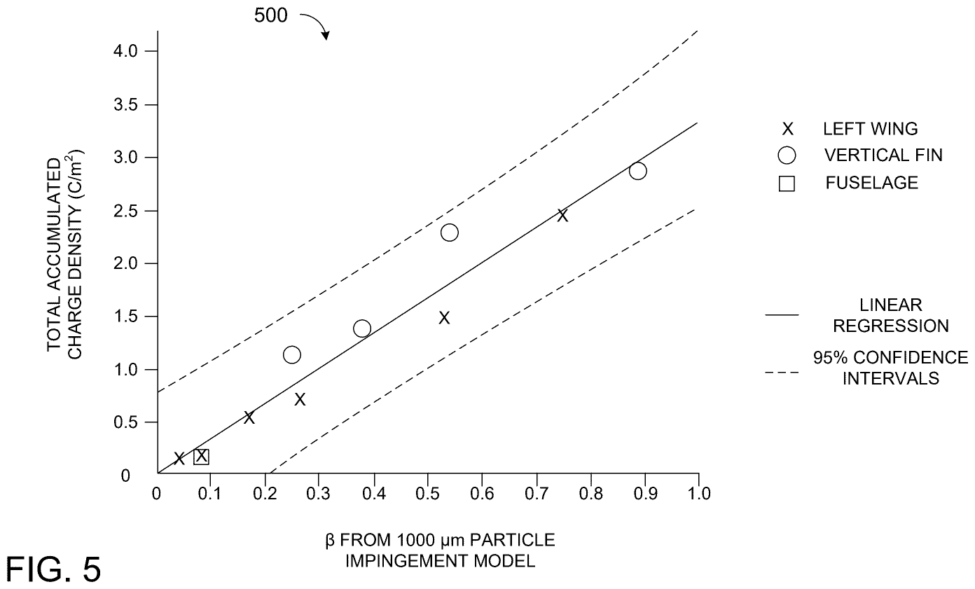

The charging profile acquired via the charging patches may be used to validate (and/or adjust) the particle impingement model. For example, uncertainty bounds for a particle impingement model may be adjusted based on the charging profile. FIG. 5 is an example plot 500 that shows the total charge accumulated (ρ) on each patch during the flight test against β_{cp} (β at the center of specific charging patch) predicted by the 1000 μm particle impingement computational fluid dynamics (CFD) model (FIGS. 3E-3F). The correlation coefficient between the ρ_{cp} and β is 0.97, indicating a very strong correlation. The largest source of uncertainty in β_{cp} comes from estimating the charge patch locations on the particle impingement model that uses in-flight geometry from simple jig geometry callouts in the installation worksheet. This uncertainty is reflected in the variability in β_{cp} with respect to ρ_{cp}. Due to the strong correlation between ρ_{cp} and β_{cp}, the result can be fit with the linear regression ρ_{cp}=C₁ β_{cp}+C₂ which gives c₁=3.3±0.5 cm² and c₂=0.0±0.3 cm². Note that because ρ_{cp} is the charge accumulated for the entire duration of the flight test, and depends on the flight conditions, the coefficient, c₁ is dependent on the specific flight or segment of flight that is analyzed. However, c₂ should always be approximately 0 cm². This fit results in R²=0.95, or 95% of the ρ_{cp} result is explained by this linear model. FIG. 5 shows this linear fit as the solid line with 95% confidence intervals (simultaneous observation bounds) as the dashed lines.

This result validates the predictive ability of β in that it is proportional to the total accumulated charge. Additionally, this result validates the use of β for predicting the charging current density profile because the accumulated charge density is linearly related to the average charging current density [symbol] over duration Δt by ρ_{cp}=∫J_{cp} dt= [symbol] Δt. This β prediction and charge patch data can therefore be used to predict the charging current density across the entire aircraft during each flight test condition, including at all unbonded conductor locations.

Returning to FIG. 2, at 230, method 200 comprises discretizing the particle impingement model to generate two or more p-static zones. As used herein, discretization is used to indicate dividing the aircraft surface into two or more distinct zones that are treated individually, even if the zone has a range of particle impingement values. Optionally, at 240, method 200 comprises discretizing the particle impingement model based on the charging profile. Discretization may be based on a correlation of an output of an impingement model with surface charge accumulation. P-static zones may be based on a combination of the two data sets and might not directly correlate with either model in totality.

P-static zones may be characterized by a charge current density severity, and wherein a stringency of p-static design guidelines for a given p-static zone correlates to the charge current density severity for the given p-static zone. Current density profiles for an aircraft surface may be generated from a combination of the validated particle impingement model and the charging patch data.

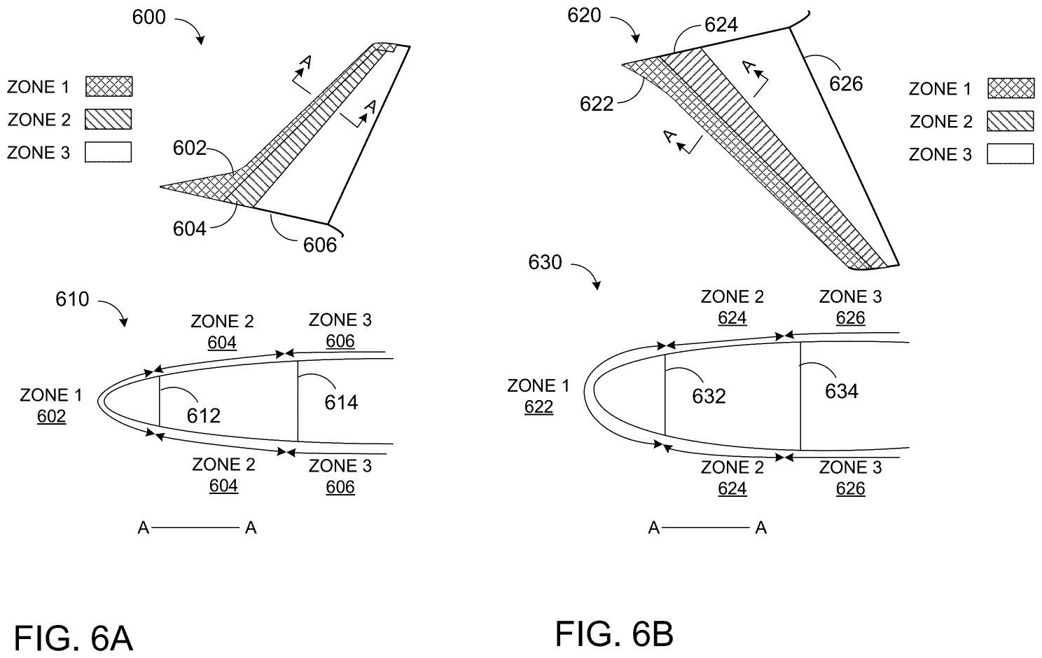

FIG. 6A schematically shows p-static zones for an aircraft fin, and FIG. 6B schematically shows p-static zones for an aircraft airfoil. FIG. 6A schematically shows an example aircraft fin 600. The surface of fin 600 is shown divided into three p-static zones—zone 1 602, zone 2 604, and zone 3 606. A cross section of fin 600 is shown at 610. While three zones are depicted, in other examples there may be as few as two zones or more than three zones.

Zone 1 602 may be considered a high β/high charging current density zone. Zone 1 602 roughly correlates to the edge of the leading-edge skin and the forward torque box skin. Zone 2 604 may be considered a medium β/medium charging current density zone. Zone 2 604 roughly correlates to the edge of the forward torque box skin and the main torque box skin. Zone 3 606 may be considered a low or negligible β/low charging current density zone. For reference, cross section 610 indicates aux spar 612 and the front spar of the main torque box 614.

FIG. 6B schematically shows an example aircraft wing 620. The surface of wing 620 is shown divided into three p-static zones—zone 1 622, zone 2 624, and zone 3 626. A cross section of wing 620 is shown at 630.

Zone 1 622 may be considered a high β/high charging current density zone. Zone 1 622 roughly correlates to the edge of the leading-edge skin and the aux box skin. Zone 2 624 may be considered a medium β/medium charging current density zone. Zone 2 624 roughly correlates to the edge of the aux box skin and the multispar box. Zone 3 626 may be considered a low or negligible β/low charging current density zone. For reference, cross section 630 indicates aux spar 632 and the front spar of the multispar box 634.

Returning to FIG. 2, at 250, method 200 comprises establishing p-static design guidelines on a per p-static zone basis. A p-static design guideline can comprise a surface area of unbonded conductive or dielectric material within the respective p-static zone. The unbonded conductive material may comprise speed tape. The dielectric material may comprise decals.

In zones with low β (and/or low charging current density), the amount of unbonded conductive material and/or dielectric material may be increased above FAA guidelines. In some examples, there may be zones with little to no restrictions on unbonded conductive material area. Zones with high β (and/or high charging current density) may allow little or no unbonded conductive material. Zones with intermediate β (and/or intermediate charging current density) may have restrictions that allow a certain area of unbonded conductive material. The p-static zones may also be based on the location of antennas relative to location on the aircraft surface. For example, an aircraft surface portion with an intermediate β that is located close to an antenna may be clustered with zones comprising surface portions with high β values. As an example, the lowest charging current observed during a test condition was 2 μA on the horizontal stabilizer and the highest was 340 μA on the nose. The relative uncertainty of these currents is 50% and 80%. However, even with high discharge rates, the coupled noise to the antennas may be sufficiently low as to not create a p-static interference issue with any of the communication or navigation systems. The tested repair patch configuration may thus bound speed tape installations of the same area in lower β regions. However, because the charging current density is lower, greater speed tape area than what is tested is also acceptable.

For each unbonded conductive patch or decal, it is known from modeling and charge patch data the exact current density is impinging or charging each one of those repair patches. The current density onto the repair patches creates the noise that then couples to the antennas. For charging patches and areas with lower current density, there would need to be more repair patches to attain an equivalent threat level. For example, repair patches may be positioned at or close to β=0.3 regions and aft from the 1000 μm particle model. Higher β regions are generally either on areas of the airplane that prohibit foil speed tape repairs (e.g., nose and radome) or are in areas of bare metal (e.g., engine inlet lip, slats, and empennage bullnose) that do not typically need speed tape repairs.

Returning to FIG. 2, at 260, method 200 comprises applying one or more of unbonded conductive material and dielectric material to the aircraft surface based on the p-static design guidelines. For example, a computing system may indicate application of unbonded conductive material and/or dielectric material to the aircraft surface to a user trained to apply the unbonded conductive material and/or dielectric material to the aircraft surface.

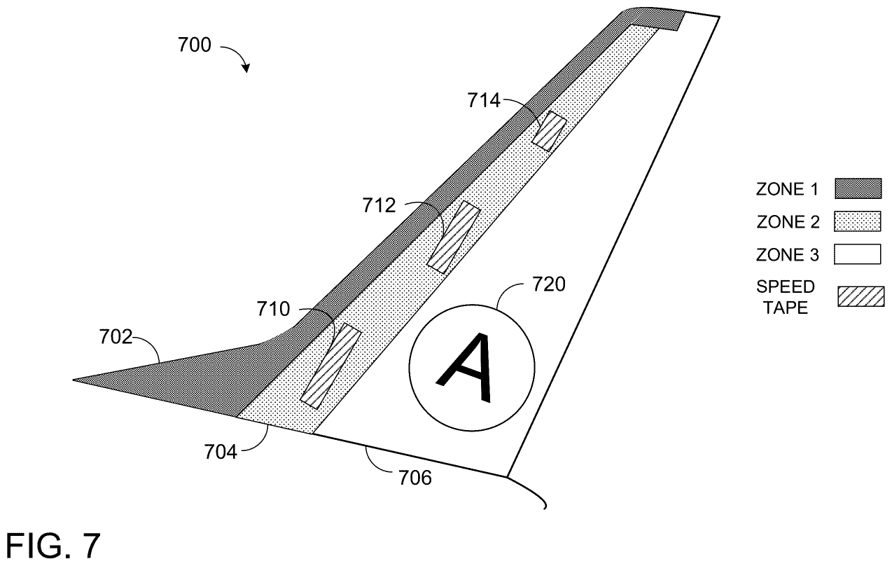

FIG. 7 illustrates unbonded conductive material and dielectric material applied to an aircraft fin on a per p-static zone basis. FIG. 7 schematically shows an example aircraft fin 700. The surface of fin 700 is shown divided into three p-static zones-zone 1 702, zone 2 704, and zone 3 706, however in other examples there may be as few as two zones or more than three zones. Zone 1 702 is a high charge current density zone that restricts any unbonded conductive material and dielectric material. Zone 2 704 is an intermediate charge current density zone that allows a certain area of unbonded conductive material and/or dielectric material. Here, speed tape is shown applied at 710, 712, and 714. Zone 3 706 is a low charge current density zone that allows unlimited unbonded conductive material and/or dielectric material, such as decal 720.

An acceptable application area for unbonded conductive material and/or dielectric material may be established per p-static zone based on the β value and/or charge current density for each zone. There exists a voltage threshold, Vₜₕᵣₑₛₕ that initiates electrostatic discharge of the average repair patch. This electrostatic discharge potentially couples to an antenna, creating p-static interference. The charge required to achieve this breakdown threshold for a single speed tape patch is Qₜₕᵣₑₛₕ=C Vₜₕᵣₑₛₕ, where C is the capacitance of the patch. The discharge rate for the patch is proportional to the charging current density and patch area and inversely proportional to the patch capacitance and voltage threshold.

Another relevant quantity when comparing two speed tape installations is the amount of energy involved in the discharge. This energy can be calculated by assuming the entire stored charge in the patch is involved in the discharge, which allows for treating the patch as discharging capacitor. The p-static threat from an isolated conductor like a repair patch (conductor n) bounds the threat of another patch (conductor m) when: 1. The number of discharges per second from conductor n is greater than that from conductor m and; 2. The discharge energy from conductor n is greater than that from conductor m. The number of discharges and discharge energy can be combined through analyzing the average power created from the discharging conductor over the duration of the test condition.

For patch clusters, the total radiated power from a patch cluster is the sum of average radiated power from each individual patch, However, the power that is available to couple to a given antenna depends on the repair patch's location on the aircraft relative to the antenna and the frequency band of the antenna. Method of moments (MoMs) simulations can be used to characterize this sensitivity.

FIG. 8 schematically shows a non-limiting embodiment of a computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices.

Computing system 800 includes a logic machine 810 and a storage machine 820. Computing system 800 may optionally include a display subsystem 830, input subsystem 840, communication subsystem 850, and/or other components not shown in FIG. 8. Computing system 800 may be utilized to perform steps of method 200, for example.

Logic machine 810 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 820 includes one or more physical devices configured to hold instructions executable by the logic machine to implement the methods and processes described herein. When such methods and processes are implemented, the state of storage machine 820 may be transformed—e.g., to hold different data.

Storage machine 820 may include removable and/or built-in devices. Storage machine 820 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 820 may include volatile, nonvolatile, dynamic, static, read/write, read-only, random-access, sequential-access, location-addressable, file-addressable, and/or content-addressable devices.

It will be appreciated that storage machine 820 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 810 and storage machine 820 may be integrated together into one or more hardware-logic components. Such hardware-logic components may include field-programmable gate arrays (FPGAs), program- and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 800 implemented to perform a particular function. In some cases, a module, program, or engine may be instantiated via logic machine 810 executing instructions held by storage machine 820. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across multiple user sessions. A service may be available to one or more system components, programs, and/or other services. In some implementations, a service may run on one or more server-computing devices.

When included, display subsystem 830 may be used to present a visual representation of data held by storage machine 820. This visual representation may take the form of a graphical user interface (GUI). As the herein described methods and processes change the data held by the storage machine, and thus transform the state of the storage machine, the state of display subsystem 830 may likewise be transformed to visually represent changes in the underlying data. Display subsystem 830 may include one or more display devices utilizing virtually any type of technology. Such display devices may be combined with logic machine 810 and/or storage machine 820 in a shared enclosure, or such display devices may be peripheral display devices.

When included, input subsystem 840 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 850 may be configured to communicatively couple computing system 800 with one or more other computing devices. Communication subsystem 850 may include wired and/or wireless communication devices compatible with one or more different communication protocols. As non-limiting examples, the communication subsystem may be configured for communication via a wireless telephone network, or a wired or wireless local-or wide-area network. In some embodiments, the communication subsystem may allow computing system 800 to send and/or receive messages to and/or from other devices via a network such as the Internet.

Further, the disclosure comprises configurations according to the following examples.

Example 1. A method for discretizing an aircraft surface into p-static zones, comprises generating a particle impingement model for an aircraft surface using computational fluid dynamics; discretizing the particle impingement model to generate two or more p-static zones; establishing p-static design guidelines on a per p-static zone basis; and applying one or more of unbonded conductive material and dielectric material to the aircraft surface based on the p-static design guidelines.

Example 2. The method of example 1, further comprising generating a charging profile for the aircraft surface based on flight test data from charging patches positioned on the aircraft surface.

Example 3. The method of examples 1-2, wherein discretizing the particle impingement model is based on the charging profile.

Example 4. The method of examples 1-3, wherein charging patches are positioned on the aircraft surface based on the particle impingement model.

Example 5. The method of examples 1-4, wherein the charging profile for the aircraft surface is further based on flight test data from instrumented static dischargers positioned on the aircraft surface.

Example 6. The method of examples 1-5, wherein p-static zones are characterized by a charge current density severity.

Example 7. The method of examples 1-6, wherein a stringency of p-static design guidelines for a given p-static zone correlates to the charge current density severity for the given p-static zone.

Example 8. The method of examples 1-7, wherein a p-static design guideline comprises a surface area of one or more of unbonded conductive material and dielectric material within the respective p-static zone.

Example 9. The method of examples 1-8, wherein the unbonded conductive material comprises speed tape, and wherein the dielectric material comprises decals.

Example 10. A computing system for discretizing an aircraft surface into p-static zones, comprises a logic machine comprising one or more processors; a storage machine comprising instructions executable by the one or more processors to generate a particle impingement model for an aircraft surface using computational fluid dynamics; discretize the particle impingement model to generate two or more p-static zones; establish p-static design guidelines on a per p-static zone basis; and indicate application of one or more of unbonded conductive material and dielectric material to the aircraft surface based on the p-static design guidelines.

Example 11. The computing system of example 10, wherein the storage machine further comprises instructions executable by the one or more processors to generate a charging profile for the aircraft surface based on flight test data from charging patches positioned on the aircraft surface, and

Example 12. The computing system of examples 10-11, wherein discretizing the particle impingement model is based on the charging profile.

Example 13. The computing system of examples 10-12 wherein charging patches are positioned on the aircraft surface based on the particle impingement model.

Example 14. The computing system of examples 10-13, wherein the charging profile for the aircraft surface is further based on flight test data from instrumented static dischargers positioned on the aircraft surface.

Example 15. The computing system of examples 10-14, wherein p-static zones are characterized by a charge current density severity.

Example 16. The computing system of examples 10-15, wherein a stringency of p-static design guidelines for a given p-static zone correlates to the charge current density severity for the given p-static zone.

Example 17. The computing system of examples 10-16, wherein a p-static design guideline comprises a surface area of one or more of unbonded conductive material and dielectric material within the respective p-static zone.

Example 18. The computing system of examples 10-17, wherein the unbonded conductive material comprises speed tape, and wherein the dielectric material comprises decals.

Example 19. A method for discretizing an aircraft surface into p-static zones, comprises generating a particle impingement model for an aircraft surface using computational fluid dynamics; generating a charging profile for the aircraft surface based on flight test data; discretizing the particle impingement model based on the charging profile to generate two or more p-static zones on the aircraft surface; and establishing p-static design guidelines on a per p-static zone basis.

Example 20. The method of example 19, wherein a p-static design guideline comprises a surface area of unbonded conductive material within the respective p-static zone.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for discretizing an aircraft surface into p-static zones, comprising:
generating a particle impingement model for an aircraft surface using computational fluid dynamics;
discretizing the particle impingement model to generate two or more p-static zones;
establishing p-static design guidelines on a per p-static zone basis; and
applying one or more of unbonded conductive material and dielectric material to the aircraft surface based on the p-static design guidelines.

2. The method of claim 1, further comprising:
generating a charging profile for the aircraft surface based on flight test data from charging patches positioned on the aircraft surface.

3. The method of claim 2, wherein discretizing the particle impingement model is based on the charging profile.

4. The method of claim 2, wherein charging patches are positioned on the aircraft surface based on the particle impingement model.

5. The method of claim 2, wherein the charging profile for the aircraft surface is further based on flight test data from instrumented static dischargers positioned on the aircraft surface.

6. The method of claim 1, wherein p-static zones are characterized by a charge current density severity.

7. The method of claim 6, wherein a stringency of p-static design guidelines for a given p-static zone correlates to the charge current density severity for the given p-static zone.

8. The method of claim 6, wherein a p-static design guideline comprises a surface area of one or more of unbonded conductive material and dielectric material within the respective p-static zone.

9. The method of claim 1, wherein the unbonded conductive material comprises speed tape, and wherein the dielectric material comprises decals.

10. A computing system for discretizing an aircraft surface into p-static zones, comprising:
a logic machine comprising one or more processors;
a storage machine comprising instructions executable by the one or more processors to:
generate a particle impingement model for an aircraft surface using computational fluid dynamics;
discretize the particle impingement model to generate two or more p-static zones;
establish p-static design guidelines on a per p-static zone basis; and
indicate application of one or more of unbonded conductive material and dielectric material to the aircraft surface based on the p-static design guidelines.

11. The computing system of claim 10, wherein the storage machine further comprises instructions executable by the one or more processors to:
generate a charging profile for the aircraft surface based on flight test data from charging patches positioned on the aircraft surface.

12. The computing system of claim 11, wherein discretizing the particle impingement model is based on the charging profile.

13. The computing system of claim 11,
wherein charging patches are positioned on the aircraft surface based on the particle impingement model.

14. The computing system of claim 11, wherein the charging profile for the aircraft surface is further based on flight test data from instrumented static dischargers positioned on the aircraft surface.

15. The computing system of claim 10, wherein p-static zones are characterized by a charge current density severity.

16. The computing system of claim 15, wherein a stringency of p-static design guidelines for a given p-static zone correlates to the charge current density severity for the given p-static zone.

17. The computing system of claim 14, wherein a p-static design guideline comprises a surface area of one or more of unbonded conductive material and dielectric material within the respective p-static zone.

18. The computing system of claim 10, wherein the unbonded conductive material comprises speed tape, and wherein the dielectric material comprises decals.

19. A method for discretizing an aircraft surface into p-static zones, comprising:
generating a particle impingement model for an aircraft surface using computational fluid dynamics;
generating a charging profile for the aircraft surface based on flight test data;
discretizing the particle impingement model based on the charging profile to generate two or more p-static zones on the aircraft surface; and
establishing p-static design guidelines on a per p-static zone basis.

20. The method of claim 19, wherein a p-static design guideline comprises a surface area of unbonded conductive material within the respective p-static zone.
